(19) United States
(12) Patent Application Publication
(10) Pub. No.: US 2009/0325630 A1
(43) Pub. Date: Dec. 31, 2009

(54) METHOD, APPARATUS, AND COMPUTER PROGRAM PRODUCT FOR PERSONALIZING A DEVICE

(75) Inventors: JOHANNA MARIA TIITOLA, Helsinki (FI); ESA KANKAANPAA, Hyvinkaa (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION, ESPOO (FI)

(21) Appl. No.: 12/163,623

(22) Filed: Jun. 27, 2008

(51) Int. Cl. H04M 1/00

(52) U.S. Cl. 455/550.1

(57) ABSTRACT

An apparatus for personalizing device may comprise a processor that may be configured to receive a request to personalize a user device based at least in part on at least one setting data of at least one application from a previous device of the user. The processor may further be configured to retrieve the at least one setting data from the previous device. The processor may also be configured to modify at least one setting of a corresponding application of the user device based at least in part on the retrieved setting data. Associated methods and computer program products may also be provided.

### TECHNICAL FIELD

Embodiments of the present invention relate generally to providing and receiving information and, more particularly, relate to a method, apparatus and a computer program product for personalizing a device.

### BACKGROUND OF THE INVENTION

The modern communications era has brought about a tremendous expansion of wireline and wireless communications and networks with unprecedented technological expansion, fueled by consumer demand. Wireless and mobile communications technologies have addressed related consumer demands, while providing more flexibility and immediacy of information transfer. The expansion of wireless communications has correspondingly generated a tremendous expansion in the use of related communication devices. These communication devices are allowing consumers to manually select personal settings or preferences for an increasing amount of applications available in these devices. In this regard, consumers can become more comfortable with the use of their communications devices.

However, as wireless and mobile communication technologies continue to improve, more devices are being developed to support these improvements. In some instances, consumers desire to purchase and replace their previous devices with new devices that are more advanced and have cutting edge technology. Although consumers no longer desire to use their previous devices, they desire the new devices to be personalized in the same manner as their previous devices. While some technologies allow personal data to be transferred from one device to another, consumers may still be required to manually select personal settings or preferences in their new device. This personalization process can be tedious, difficult, and expansive, depending on the number of applications that have been personalized on the previous device.

In this regard, consumers can spend long periods of time in personalizing their new devices. Additionally, the personalization may be complex enough to require the assistance of others, due to the difference in technology. As such, although consumers desire or are required to use new devices, a number of these consumers would rather avoid the hassle of personalization. Accordingly, some consumers may simply not purchase new devices so as to avoid the investment required to personalize the new device, thereby potentially negatively effecting the sale of communication devices is negatively affected.

In light of the above, it may be desirable to at least partially address at least some of the problems discussed above by providing methods, apparatuses, and computer program products that facilitate the personalization of a new device.

### BRIEF SUMMARY OF THE INVENTION

A method, apparatus and computer program product may therefore be provided that may automatically personalize a device. In this regard, embodiments of the present invention may automatically personalize a second device of a user based at least in part on the personal or preferred settings of a user's first device. In some embodiments, the applications of the second device may be compared to the applications of the first device to identify the data that may be retrieved and/or transferred from the first device. In other embodiments, data may be retrieved and/or transferred from the first device to the second device via various communications techniques including, but not limited to, infrared, wireless LAN, or BlueTooth techniques. In yet other embodiments, information regarding settings data that may be retrieved and/or transferred may be recorded in a file and the second device may be personalized based at least in part on the content of the file.

In one exemplary embodiment, a method for personalizing a device is described. The method may include receiving a request to personalize a second device. In various embodiments, the personalization may be based at least in part on a first device. The method may also include comparing at least one application from the first device to at least one application from the second device. The method may further include determining at least one setting data to be retrieved from the first device. In various embodiments, the determination may be based at least in part on the comparison. The method may additionally include retrieving the at least one setting data from the first device. The method may also include modifying at least one setting of at least one application of the second device based at least in part on the retrieved setting data. In various embodiments, the modification may be based on at least in part on the retrieved setting data.

In another exemplary embodiment, an apparatus for personalizing a device is described. The apparatus may include a processor configured to receive a request to personalize a second device. In some embodiments, the personalization may be based at least in part on a first device. The processor may be further configured to compare at least one application from the first device to at least one application from the second device. The processor may also be configured to determine at least one setting data to be retrieved from the first device. In various embodiments, the determination may be based at least in part on the comparison. The processor may additionally be configured to retrieve the at least one setting data from the first device. The processor may also be configured to modify at least one setting of at least one application of the second device based at least in part on the retrieved setting data. In various embodiments, the modification may be based on at least in part on the retrieved setting data.

In yet another exemplary embodiment, a computer program product for personalizing a device is described. The computer program product may include at least one computer-readable storage medium having computer-readable program instructions stored therein. The computer-readable program instructions may include first, second, third, fourth, and fifth program instructions. The first program instruction may be configured to receive a request to personalize a second device. In various embodiments, the personalization may be based at least in part on a first device. The second program instruction may be configured to compare at least one application from the first device to at least one application from the second device. The third program instruction may be configured to determine at least one setting data to be retrieved from the first device. In various embodiments, the determination may be based at least in part on the comparison. The fourth program instruction may be configured to retrieve the at least one setting data from the first device. The fifth program instruction may be configured to modify at least one setting of at least one application of the second device. In various embodiments, the modification may be based on at least in part on the retrieved setting data.

In yet another exemplary embodiment, an apparatus for personalizing a device is described. The apparatus may include a means for receiving a request to personalize a second device. In various embodiments, the personalization may be based at least in part on a first device. The apparatus may also include a means for comparing at least one application from the first device to at least one application from the second device. The apparatus may further include a means for determining at least one setting data to be retrieved from the first device. In various embodiments, the determination may be based at least in part on the comparison. The method may additionally include a means for retrieving the at least one setting data from the first device. The method may also include a means for modifying at least one setting of at least one application of the second device based at least in part on the retrieved setting data. In various embodiments, the modification may be based on at least in part on the retrieved setting data.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 illustrates a block diagram showing an apparatus for personalization of a device with associated network connectivity according to an example embodiment of the present invention;

FIG. 3 illustrates an example of a portion of data and/or content of a first device according to one embodiment of the present invention;

FIG. 4 illustrates an example of a portion of a file containing information regarding compatible data according to one embodiment of the present invention; and

FIG. 6 is a flowchart according to methods for personalizing a user device according to embodiments of the present invention.

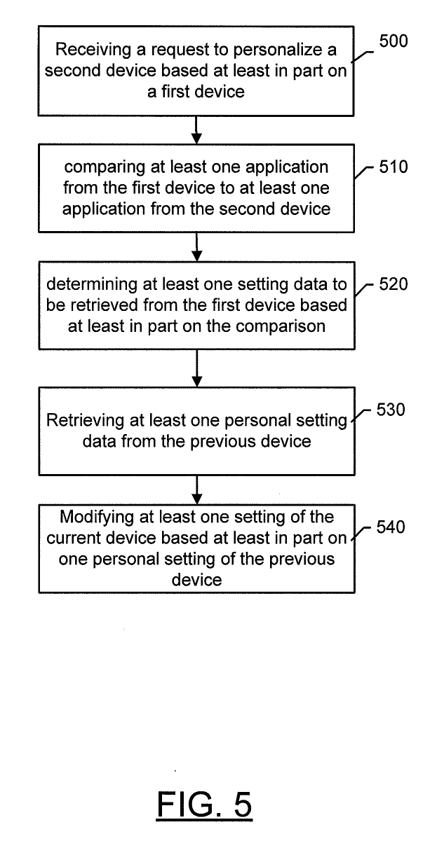

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

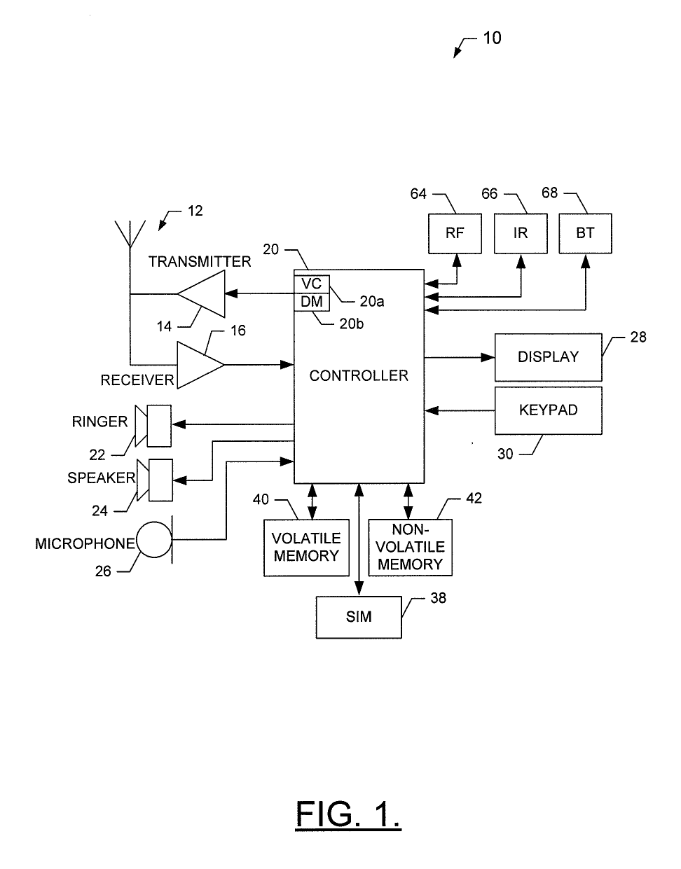

FIG. 1 illustrates a block diagram of a mobile terminal 10 that may benefit from embodiments of the present invention. It should be understood, however, that the mobile terminal illustrated and hereinafter described is merely illustrative of one type of electronic device that may benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ the present invention.

As shown, the mobile terminal 10 may include an antenna 12 in communication with a transmitter 14 and a receiver 16. The mobile terminal may also include a controller 20 or other processor that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless local area network (WLAN) techniques such as IEEE 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, 3.9G, fourth-generation (4G) communication protocols, and/or the like. For example, the mobile terminal may be capable of operating in accordance with 2G wireless communication protocols IS-136 (time division multiple access TDMA), global system for mobile (GSM), and IS-95 (Code division multiple access CDMA). Also, for example, the mobile terminal may be capable of operating in accordance with 2.5G wireless communication protocols general packet radio service (GPRS), Enhanced Data rates for GSM Evolution (EDGE), or the like. Further, for example, the mobile terminal may be capable of operating in accordance with 3G wireless communication protocols such as Universal Mobile Telecommunications System (UMTS), CDMA2000, Wideband Code Division Multiple Access (WCDMA) and Time Division-Synchronous Code Division Multiple Access (TD-SCDMA). The mobile terminal may be additionally capable of operating in accordance with 3.9G wireless communication protocols such as Limited Term Evolution (LTE) or Evolved Universal Terrestrial Radio Access Network (E-UTRAN). Additionally, for example, the mobile terminal may be capable of operating in accordance with fourth-generation (4G) wireless communication protocols or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise the circuitry desirable for implementing audio and logic functions of the mobile terminal 10. For example, the controller 20 may comprise various processing means including a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a Web browser. The connectivity program may allow the mobile terminal 10 to transmit and receive Web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive Web content across Internet 50.

The mobile terminal 10 may also comprise a user interface including a conventional earphone or speaker 24, a ringer 22, a microphone 26, a display 28, a user input interface, and/or the like, which may be coupled to the controller 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise conventional numeric (0-9) and related keys (#, *), and/or other keys for operating the mobile terminal.

As shown in FIG. 1, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

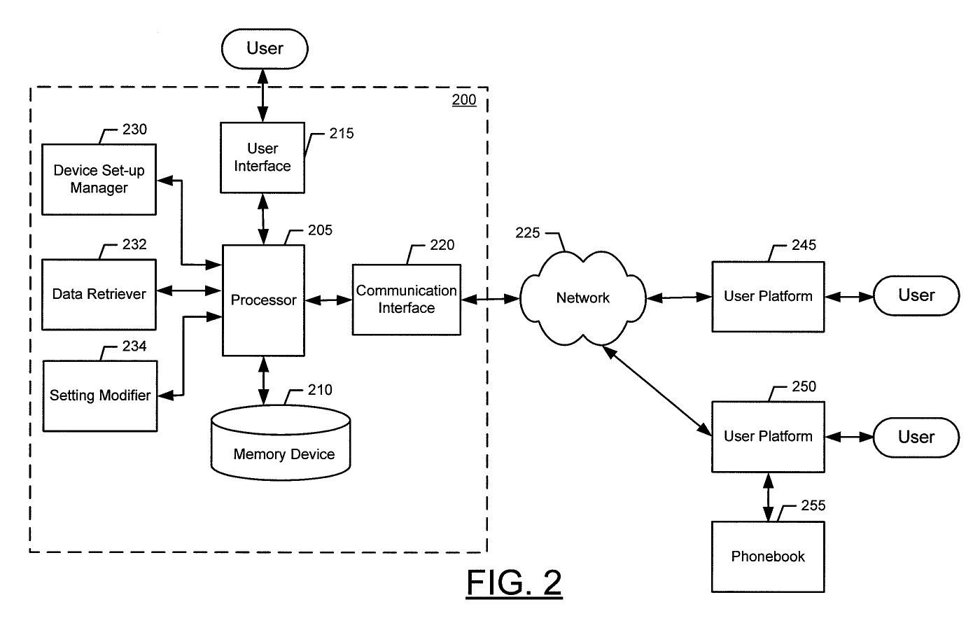

Referring now to FIG. 2, an example apparatus 200 for providing software application invitations is described. Apparatus 200 may be embodied as a network element, e.g. a server, or other network device including, for example, a mobile terminal, such as mobile terminal 10 of FIG. 1. The apparatus 200 may include or otherwise be in communication with a processor 205, a user interface 215, a communication interface 220, and a memory device 210. The memory device 210 may include, for example, volatile and/or non-volatile memory (e.g., volatile memory 40 and/or non-volatile memory 42). The memory device 210 may be accessed via a local network, or available remotely. In other embodiments, the memory device 210 may be separate from apparatus 200 but may be accessed by apparatus 200 via a local network, or available remotely. The memory device 210 may be configured to store information, data, applications, instructions, or the like for enabling the apparatus to carry out various functions in accordance with example embodiments of the present invention. For example, the memory device 210 could be configured to buffer input data for processing by the processor 205. Additionally or alternatively, the memory device 210 could be configured to store instructions for execution by the processor 205. As yet another alternative, the memory device 210 may be one of a plurality of databases that store information in the form of static and/or dynamic information, for example, in association with user contacts, one or more achievement tables, a log of software applications invitations, and/or the like.

The processor 205 may be embodied in a number of different ways. For example, the processor 205 may be embodied as various processing means including a microprocessor, a coprocessor, a controller (e.g., controller 30 from FIG. 1), or various other processing elements including integrated circuits such as, for example, an ASIC (application specific integrated circuit) or FPGA (field programmable gate array). In an example embodiment, the processor 205 may be configured to execute instructions stored in the memory device 210 or otherwise accessible to the processor 205.

The user interface 215 may be in communication with the processor 205 to receive an indication of a user input at the user interface 215 and/or to provide an audible, visual, mechanical, or other output to the user. As such, the user interface 215 may include, for example, a keyboard, a mouse, a joystick, a touch screen display, a conventional display, a microphone, a speaker, or other input/output mechanisms. For example, in an embodiment in which the apparatus 200 is embodied as a mobile terminal (e.g., the mobile terminal 10 of FIG. 1), the user interface 215 may include, among other devices or elements, any or all of the speaker 24, the ringer 22, the microphone 26, the display 28, and the keyboard 30. In an example embodiment in which the apparatus 200 is embodied as a server, the user interface 215 may be limited, or even eliminated.

The communication interface 220 may be embodied as any device or means embodied in either hardware, software, or a combination of hardware and software that is configured to receive and/or transmit data from/to a network and/or any other device or module in communication with the apparatus 200. In this regard, the communication interface 220 may include, for example, an antenna, a transmitter, a receiver, a transceiver, a network card, network adapter, network interface card and/or supporting hardware or software for enabling communications with network 225, which may be any type of wired or wireless network. The communication interface 220 may enable the receipt and transmission of communications with remote devices (e.g., a user platform 245 and 250, or the like). For example, in an embodiment in which the apparatus 200 is embodied as a mobile terminal (e.g., the mobile terminal 10 of FIG. 1), the communication interface 225 may include, among other devices or elements, any or all of an antenna 12, a transmitter 14, a receiver 16, a radio frequency (RF) transceiver and/or interrogator 64, an infrared (IR) transceiver 66, a Bluetooth™ (BT) transceiver 68, an internal voice coder (VC) 20a, and an internal data modem (DM) 20b. As used herein, “communications” and “communication events” may be used interchangeably and may include, but are not limited to, phone calls, short message service (SMS) messages, multimedia messaging service (MMS) messages, e-mails, Internet Protocol communication and/or the like, and transfer or other sharing of files between the apparatus 200 and the remote devices. Sometimes as used herein, the generic term “messages” may be used to refer to SMS messages, MMS messages, e-mails, file transfers and/or the like. As such, via the communication interface 220 and the network 225, the apparatus 200 may communicate with the user platform 245 and/or the user platform 250.

The user platforms 245, 250 may be any type of device for storing, retrieving, computing, transmitting and receiving data. In some embodiments, user platforms 245, 250 may be embodied as a mobile terminal 10 of FIG. 1 or the like. Alternatively, the user platforms may be fixed, such as in instances in which a work station serves as a user platform. User platforms 245, 250 are representative of a plurality of user platforms, and as such any number of user platforms may be included in FIG. 2. User platform 250, as well as any other user platform, may also be associated with a phonebook 255. The phonebook 255 may include data including user contacts and additional associated information. The phonebook 255 may be stored on a memory device that is included with the user platform 255 or external to the user platform 250. As mentioned above, in an embodiment in which the apparatus 200 is embodied as a mobile terminal (e.g., the mobile terminal 10 of FIG. 1), the communication interface 220 may enable the receipt and transmission of data and communications directly with remote devices (e.g., user platforms 245 and 250, or the like) via various communication techniques including radio frequency (RF), an infrared (IR), a Bluetooth™ (BT), and/or the like, in accordance with various embodiments of the present invention.

The apparatus 200 may also include a device set-up manager 230, a data retriever 232, and a setting modifier 234 which may be any means or device embodied in hardware, software, or a combination of hardware and software that is configured to carry out the respective functions as described herein. In an example embodiment, the processor 205 may include, or otherwise control the device set-up manager 230, the data retriever 232, and the setting modifier 234. In various example embodiments, the device set-up manager 230, the data retriever 232, and the setting modifier 234 may reside on a server, or other network device including a mobile terminal, such as mobile terminal 10 of FIG. 1.

The device set-up manager 230 may be a software or hardware application residing and operating on apparatus 200 that may be configured to assist a user in setting up a second device, and as such, may be embodied by various means, the processor 205, which may execute computer instructions stored, for example, in memory device 210 and may facilitate user interaction via user interface 215 and/or communication interface 220. As used herein, “second device” may be used to refer to a device that a user may be planning on using in the stead of a first or current device, or in other words, a device that may be replacing another device currently being used by a user. For example, the second device may be a new device. Further, “new device” may not mean a device that may be newly introduced to the market or new to the user, but may just instead mean newly personalized. The second device may be apparatus 200 embodied as a mobile terminal, such as mobile terminal 10 of FIG. 1. The device set-up manager 230 may include one or more applications or user interface elements, such as, for example, wizard applications generally executed by processor 205. In this regard, a user may power up the second device to use it for the first time, whereupon the device set-up manager 230 may be automatically launched. The device set-up manager 230 may also be manually launched upon subsequent powering up of the second device for use. In other embodiments, the device set-up manager 230 may be launched automatically upon powering up of the device a second or additional time subsequent to the device being reset to the original or factory settings.

As mentioned above, the device set-up manager 230 may be configured to assist a user in setting up a second device, which may comprise assisting the user in personalizing or customizing the device. In this regard, the device set-up manager 230 may present to the user a selection of applications or user interface elements that may be executed to set-up the device. The user may desire to personalize the second device based at least in part on a first device and select the appropriate application to personalize on the second device. In some embodiments, the first and second devices may both belong to the same user. In other embodiments, a user may be personalizing a second device, belonging to the user, based at least in part on a first device belonging to another user. In other words, the first and second devices may belong to two different users. As used herein, “first device” may be used to refer to a device that a user may be planning on no longer using, or in other words, a device that may be replaced by another device, or may not be using exclusively going forward. For example, the first device may be a previous device of the user. In this regard, an initial step in personalizing the device may be to retrieve and/or transfer data from the user's first device.

The data retriever 232 may be a software or hardware application that may reside and/or operate on apparatus 200 and may be configured to retrieve and/or transfer data from the user's first device. The data retriever 232 may be embodied by various means including the processor 205, which may execute computer instructions stored, for example, in memory device 210. The first device may be embodied as user platform 245 or 250. The user may be presented with a selection of data to retrieve and/or transfer from the user's first device. The selection of data may include user contacts data, calendar data, user preferred or personal settings data, MMS and/or SMS messages data, images/pictures data, sound clips data, video clips data, other media files data, applications and/or the like. As used herein, “user preferred” and “personal settings data” may be interchangeably be used to refer to the value of the one or more preferred settings of the one or more applications of the first device selected by the user such as, for example, profile settings, phonebook/addressbook settings, standby settings, display settings, date and time settings, calendar settings, softkeys settings, Bluetooth settings, writing settings, language settings, other device settings, and/or the like.

In this regard, profile settings may include profile name, ringing tone, ringing type, ringing volume, message alert tone, e-mail alert tone, vibrating alert, keypad tones, warning tones, alerted calls setting, other tone settings, and/or the like. Phonebook/addressbook settings may include display order of contact names, group specific ringing tones, size of contact thumbnail, and/or the like. Stand by settings may include active standby setting (on/off), active standby applications, and/or the like. Display settings may include screen saver timeout setting, wallpaper setting, display time-out setting, and/or the like. Date and time settings may include time zone, date format, date separator, time format, time separator, clock type (analog/digital), and/or the like. Calendar settings may include alarm tone, default view, week view title, and/or the like. Writing settings may include writing language, T9 setting (on/off), T9 dictionary, and/or the like.

The user may select user preferred or personal settings data and/or one or more of these additional different types of data to retrieve and/or transfer from the first device. In this regard, the data retriever 232 may first access and analyze the content and/or data of the first device to determine the compatibility between the two devices, and thus, the data that may be retrieved and/or transferred to the second device. In embodiments where the first and second devices belong to different users, the owner of the second device may request permission or authorization from the other user to access the first device and transfer user preferred settings and/or other data to the second device. In some embodiments, the authorization may be manually provided by the owner of the first device. For example, the first device may receive a request from the second device whereupon the owner of the first device may be prompted to depress a button or key on the first device to authorize access to the first device. In another example, the owner of the first device may provide an access code to the owner of the second device for accessing the first device. In this regard, the owner of the second device may input the access code along subsequent to the second device submitting an access request to the first device. In some embodiments, the authorization may be automatic. In this regard and as example, the first device may recognize the second device as a trusted source and automatically allow access to data on the first device. In this regard, the request submitted by the second device to access the first device may include a code to access the data of the first device.

In some embodiments, the first device and the current device may be in direct communication with each other via various communication techniques such as, for example, radio frequency (RF), infrared (IrDA) or any of a number of different wireless networking techniques, including wireless LAN (WLAN) techniques such as IEEE 3162.11 (e.g., 3162.11a, 3162.11b, 3162.11g, 3162.11n, etc.), WiMAX techniques such as IEEE 3162.16, and/or wireless Personal Area Network (WPAN) techniques such as IEEE 3162.15, BlueTooth (BT), and/or the like. In this regard, the second device may access, retrieve and/or transfer from the first device data and content via RF, IrDA, WLAN, BT, and/or the like. The devices may be in communication in a more indirect fashion such as, for example, via network

There may be differences between the technology or technical capabilities of the first device and the second device. For example, there may be a difference between the applications or products of the first device and the second device. In the alternative or additionally, there may be a difference between the software platforms or operating systems of the first device and the second device. For example, the second device may have a bigger screen size than that of the first device. As such, the data related to the size of the background image of the first device may not be compatible with the second device and therefore may be unnecessary to be retrieved and/or transferred to the second device. In yet another alternative or additionally, some data may not be retrieved and/or transferred, such as, for example, Digital rights management (DRM) data, other content protected data, data that are not compatible with the second device and/or the like. In some embodiments, the data compatibility may be performed by comparing each of the applications of the second device to each of the applications of the first device to determine a match therebetween. In the event similar applications are found, a further comparison between each of the features of the similar applications may be performed, as features may vary from a version of one application to another.

In some embodiments, the data retriever 232 may transfer to the first device information regarding the second device, such as, for example, information regarding the one or more applications of the first device, the one or more features of each application, the one or more settings of each application, the one or more file formats supported by the second device, and/or the like. This information may be written to a file that may be transferred to the first device and/or temporarily stored in a temporary storage location on the first device. In some embodiments, the file may be in various formats such as, for example, an Extensible Markup Language (XML) format, and/or the like. The data retriever 232 may analyze the content, data, and/or information regarding the first device and compare the information regarding the first device to the information regarding the second device transferred to the first device. In some embodiments, the data retriever 232 may read and compare the data in the file containing the information regarding the second device to the information regarding the first device using various data comparing algorithms. As such, compatible data may be identified and transferred to the second device, while the non-compatible data may be identified and prevented from being transferred.

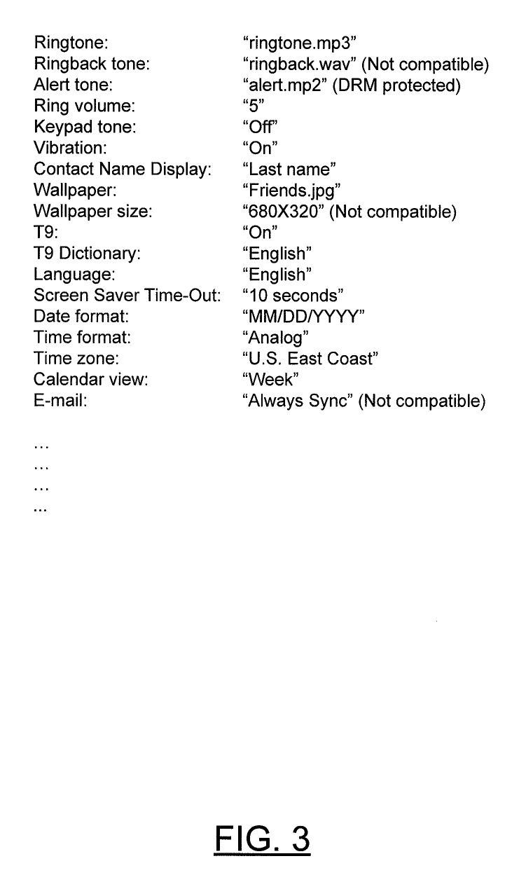

In this regard and referring now to FIG. 3, a portion of content and/or data of the first device are illustrated. As such, the ringtone application of the first device may be set to “ringtone.mp3”. The data retriever 232 may identify this setting as compatible data that may be retrieved and/or transferred to the second device. The ringback tone application may be set to “ringback.wav”. The data retriever 232 may identify this setting as non-compatible data that may not be retrieved and/or transferred to the second device. A reason may be that the second device does not support files with ”.wav” extension. Similar to the ringback tone application, the data retriever 232 may identify the settings of the alert tone, wallpaper size, and the e-mail applications may not be data compatible with the second device. For example, the setting of the alert tone application may not be retrieved and/or transferred because “alert.mp2” may be Digital Right Management (DRM) protected data. Further the setting of the wallpaper size application may not be compatible with the second device and the second device may have different screen sizes. For example, the screen size of the second device may be smaller than the first device. Additionally, the setting of the e-mail application may not be compatible with the second device because the second device may not support an e-mail application. Similar to the ringtone application, the data retriever 232 may identify the settings of the ring volume, the keypad tone, the vibration, contact name display and the remaining applications as compatible data that may be retrieved and/or transferred to the second device.

Referring back to FIG. 2, subsequent to determining the compatibility between the two devices and identifying the data that may be retrieved and/or transferred or compatible data, the data retriever 232 may proceed to retrieve and/or transfer data from the first device to the second device. The data retriever 232 may also delete the file containing information regarding the second device from the temporary storage location on the first device. As used herein, “compatible data” may be used to refer to user preferred or personal settings data and/or one or more additional types of user data, as discussed above, that may be retrieved and/or transferred from the previous device to the second device. The compatible data may be retrieved and/or transferred from one or more applications of the previous device to the one or more corresponding applications in the second device. While the retrieval and/or transfer of compatible user preferred or personal settings data may be performed in a substantially short period of time, the retrieval and/or transfer of the additional types of compatible data, such as, for example, media files, may be require a substantially longer period of time, based on the size of the data. As such, once started, the retrieval and/or transfer of the compatible data may be moved to a background process by the device set-up manager 230 and/or the data retriever 232 and hence the process may become invisible to the user. In this regard, the user may proceed with a further set-up, use, and/or the like of the second device, performing various functions with the second device, and/or the like.

The device set-up manager 230 and/or the data retriever 232 may also be configured to notify the user to maintain the first and second devices in close range in order to maintain the connection therebetween. In some embodiments, the device set-up manager 230 may be configured to notify the user of the status of the retrieval and/or transfer. For example, the device set-up manager 230 and/or the data retriever 232 may be configured to notify the user if the transfer is interrupted due to various reasons, such as, for example, the devices no longer in range, power failure of one or more devices, and/or the like. In some embodiments, in the event the retrieval and/or transfer is interrupted, the compatible data that has already been retrieved and/or transferred to the second device may remain on the second device. Nevertheless, the device set-up manager 230 and/or the data retriever 232 may notify the user of the interruption, at which point, the user may restart the data retrieval and/or transfer. In this regard, the data retrieval and/or transfer may be resumed wherein the remaining compatible data may be retrieved and/or transferred to the second device. In some embodiments, the data retrieval and/or transfer may start over from the beginning and compatible data already retrieved and/or transferred may be overwritten on the second device. In other embodiments, data that has already been retrieved and/or transferred may be deleted and thus retrieved and/or transferred anew. The device set-up manager 230 may also be further configured to provide a final notification to the user regarding the status of the retrieval and/or transfer, in the event the device set-up manager 230 is terminating and the retrieval and/or transfer of data is pending. As such, the user may be on notice to maintain the devices within each other's range to maintain communication therebetween.

In some embodiments, the personalization of the second device may be performed as the first task in the set-up of the second device. However, the personalization of the second device may be performed at other times and in different order. In this regard, user preferred or personal settings data may be first retrieved and/or transferred from the previous device to the second device. As used herein, “personalization”, “personalize”, or “personalization of the second device”, may be used interchangeably to refer to modifying the settings of the second device based at least in part on the user preferred or personal settings data of the previous device. In some embodiments, the data of each application may be simultaneously retrieved and/or transferred as a bundle from the first device to the second device. The data may then be distributed to the corresponding or similar application(s) on the second device. In other embodiment, the data retrieval and/or transfer may be sequential. In this regard, data from one application on the previous device may be retrieved and/or transferred to a corresponding application on the second device.

The data retriever 232 may also be configured to generate a file and maintain a record or a log of the compatible user preferred or personal settings data and data related thereto retrieved from the previous device in the file, e.g. a user preferred or personal settings data file. In some embodiments, the user preferred or personal settings data file may only be used once to personalize the second device. As such the user preferred or personal settings data file may be temporary and thus stored on the second device in a temporary storage location. In this regard, the temporary storage location (not shown) may be a section of memory device 210. In some embodiments, the temporary storage location may be a memory device other than but similar to memory device 210. In some embodiments, the user preferred or personal settings data file may be in various formats such as, for example, an Extensible Markup Language (XML) format, and/or the like. The user preferred or personal settings data file may contain information related to the compatible user preferred or personal settings data for each compatible user preferred or personal settings data such as, for example, the application of the first device from which the data was retrieved, the value of the setting data, the corresponding application on the second device, and/or the like. In the event, the user preferred or personal setting data involves an additional type of data, such as, for example, media file or application file, the user preferred or personal settings data file may also include the storage location of the data file. The storage location may be associated with a corresponding application on the second device. In this regard, and in some embodiments, the data retriever 232 may be configured to transfer the actual media file or all the media file of the same types such as, for example, all pictures, video, or music files, to a storage location associated with a corresponding application on the second device.

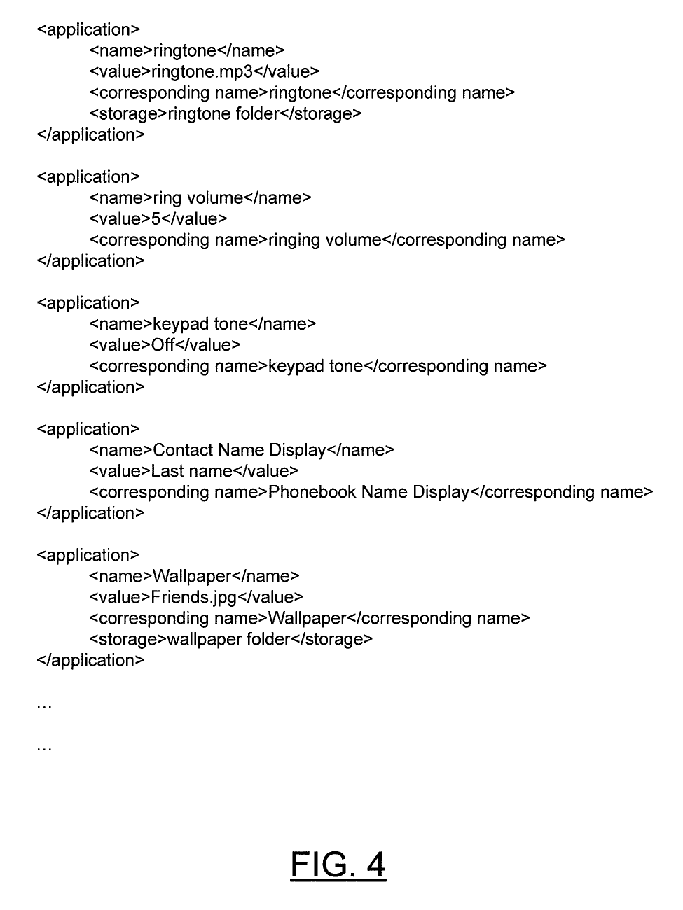

For example, and referring now to FIG. 4, the XML file may be structured in various ways. For example, the XML file may be organized by application. Each application tag may include a tag for the application name on the previous device, the settings value of the application on the previous device, and the corresponding application name in the second device. In some embodiments, the application tag may also include a tag for the storage location indicating the location of the transferred data file corresponding to the application. As an example, the ring volume application of the previous phone may have a setting value of “5” in FIG. 3. As such, and referring back to FIG. 4, the user preferred or personal settings data XML file may include “ring volume” as the application name on the previous device, “ringing volume” as the corresponding application name on the second device, and “5” as the value of the setting. In a different example, the ringtone application on the previous device may have a setting value of“ringtone.mp3.” As such, while the value of“ringtone.mp3” may be recorded in the user preferred or personal settings data file for ringtone application, the actual media file “ringtone.mp3” may be transferred to a storage location associated with a corresponding application on the second device. In this regard, the user preferred or personal settings data file may include the storage location of “ringtone.mp3” on the second device. As discussed above, the user preferred or personal settings data file may contain the compatible user preferred or personal settings data of the previous device. In this regard, in the XML user preferred or personal settings data file, there may be no information provided for certain applications, such as for example, the ringback tone and alert tone applications, although those applications were found on the previous device. The reason may be various lack of compatibility issues with the second device as previously discussed. Indeed, the second device may not support files with ”.wav” extensions. Further, the alert tone file,“alert.mp2”, may not be retrieved and/or transferred because the file may be DRM protected.

In some embodiments, the data retriever 232 may generate a list of a pre-defined list of user preferred or personal settings, that may be desirable to be retrieved from the first device such as, for example, profile settings, phonebook/addressbook settings, standby settings, display settings, date and time settings, calendar settings, softkeys settings, Bluetooth settings, writing settings, language settings, other device settings, and/or the like. This list may identify one or more applications with one or more settings and may be expandable by the device set-up manager 230 and/or the data retriever 232. The pre-defined list of user preferred or personal settings may include the settings data of the second device. The data retriever 232 may transfer the pre-defined list to the first device and may compared the information in the pre-defined list to the information contained on the first device to identify compatible data. In this regard, the data retriever may perform a setting by setting comparison or compatibility analysis between the settings on the pre-define list and the information contained on the first device. The identified compatible data may be used to update the corresponding settings in the pre-defined list. For example, the data retriever may consider the settings of the phonebook application of the second as contained on the pre-defined list, identify a corresponding application and compatible data settings on the first device, and update the settings of the phonebook application on the pre-defined list. If a corresponding application and/or setting are not found on the first device, the data retriever 232 may proceed with the following setting and/or application on the pre-defined list. The data retriever 232 may perform a similar comparison for each setting on the pre-define list and then transfer the pre-defined list back to the second device, whereupon the pre-defined list may be temporarily stored in a temporary location.

In some embodiments, the pre-defined list may be stored in a pre-defined list of user preferred or personal settings file and the file may be transferred to the first device. In some embodiments, the pre-defined list of user preferred or personal settings data file may be in various formats such as, for example, an Extensible Markup Language (XML) format, and/or the like, and may be organized and contain data in a manner similar to our discussion above related to the user preferred or personal settings data file. In this regard, the data retriever 232 may read the content of the file, perform an analysis to identify compatible data, and update the settings data on the file based on the compatible data for each setting contained on the file as discussed above. In this regard, in the event, the user preferred or personal setting data involves an additional type of data, such as, for example, media file or application file, the user preferred or personal settings data file may also include the storage location of the data file. The storage location may be associated with a corresponding application on the second device. Thereafter, the data retriever 232 may transfer the file back to the second device, whereupon the pre-defined list of user preferred or personal settings file may be temporarily stored in a temporary location. In some embodiments, the pre-defined list of user preferred or personal settings file and the user preferred or personal settings file may be the same file.

As such and referring back to FIG. 2, the user preferred or personal settings data file may be used by, for example, the setting modifier 234 and/or the data retriever 232 to identify one or more applications of the first device and the corresponding one or more applications on the second device and modify the setting(s) of the corresponding of one or more applications, based at least in part on the compatible user preferred or personal settings data. In some embodiments, the data retriever 232 may be configured to write to or populate the user preferred or personal settings data file as the compatible user preferred or personal settings data are being retrieved and/or transferred. In other embodiments, the data retriever 232 may be configured to write to or populate after the compatible user preferred or personal settings data have been retrieved and/or transferred.

As discussed above, the retrieval and/or transfer of data may be interrupted. In this regard, the user preferred or personal settings data file may be deleted and generated anew upon the retrieval and/or transfer of data being restarted. In other embodiments, the user preferred or personal settings data may be kept and the data retriever 232 may be configured to continue to record the remaining user preferred settings data, similar to the discussion above. In yet other embodiments, the user preferred or personal settings data already recorded may be overwritten.

In other embodiments, the compatibility analysis may be performed on the second device. In this regard, the data retriever 232 may retrieve and/or transfer the information contained on the first device, such as, for example, user contacts data, calendar data, user preferred or personal settings data, MMS and/or SMS messages data, images/pictures data, sound clips data, video clips data, other media files data, applications and/or the like. Subsequent to the transfer, the data retriever 232 may perform a compatibility analysis by comparing the information contained on the first device, that has been transferred to the second device, to the information of contained on the second device in a manner similar to the discussion above. As such, the identified compatible data may remain on the second device while the data identified as non-compatible may be deleted from the second device. In some embodiments, the data retriever 232 may be configured to write to or populate user preferred or personal settings data identified as compatible to a user preferred or personal settings data file and store other compatible data of a compatible application of the first device in a storage location associated with a corresponding application of the second device.

The setting modifier 234 may be configured to modify the settings of the second device based at least in part on the user preferred or personal settings data of the first device recorded in the user preferred or personal settings data file. In this regard, the setting modifier 234 may be embodied by various means including the processor 205, which may execute computer instructions stored, for example, in memory device 210. In some embodiments, the device set-up manager 230 may include the setting modifier 234.

In some embodiments, the setting modifier 234 may first determine whether the user preferred or personal settings data file and/or the pre-defined list of user preferred or personal settings file may be found on the second device. Hereinafter, the “user preferred or personal settings data file” and/or the “pre-defined list of user preferred or personal settings file” may b referred collectively as the user preferred or personal settings data file. The user preferred or personal settings data file may be stored in a predetermined storage location. In this regard, the settings modifier 234 may search for the user preferred or personal settings data file in a predetermined storage location on the second device. As mentioned above, the storage location may be a section of memory device 210 or a memory device other than but similar to memory device 210. The setting modifier 234 may also be configured to search in alternative storage locations on the second device. In the event the user preferred or personal settings data file is not found on the second device, the setting modifier 234 may proceed to apply the default factory settings which may be maintained on the system of the second device. In some embodiments, the setting modifier may take further action as the default factory setting may have already been applied on the second device. In this regard, the user preferred or personal settings data file may not be created for various reasons such as poor connection between the devices, the devices being out of each other's range, a longer time being required to gather and record the user preferred or personal settings data due to a large amount of information involved, and/or the like. However, in the event the user preferred or personal settings data file is found on the second device, the setting modifier may proceed to access and analyze the content of the file.

In some embodiments, the setting modifier 234 may simultaneously modify the settings of corresponding applications on the second device based on the user preferred or personal settings data file. In this regard, the setting modifier 234 may analyze the entire user preferred or personal settings data file and thereafter simultaneously modify all the corresponding applications in the second device. In other embodiments, the setting modifier 234 may sequentially modify the settings of corresponding applications on the second device based on the user preferred or personal settings data file. In this regard, the setting modifier 234 may analyze one setting data and modify the corresponding application, and so on until the entire user preferred or personal settings data file is analyzed. In yet other embodiments, the setting modifier 234 may analyze the entire user preferred or personal settings data file and thereafter modifying one corresponding application after the other. After the setting modifier 234 has analyzed the entire user preferred or personal settings data file and/or modified the settings of the corresponding applications, the user preferred or personal settings data file may be deleted. Analyzing the file may include the setting modifier 234 parsing the file to retrieve information such as, for example, at least one user preferred setting and at least one corresponding application.

In this regard and as an example, the setting modifier 234 may analyze a portion of the user preferred or personal settings data file as exemplified in FIG. 4. As mentioned above, by analyzing the file may include the setting modifier 234 parsing the file to retrieve at least one user preferred setting. As such, the portion may indicate that the ring volume application of the first device has a value of “5” and that the corresponding application in the second device is ringing volume. Accordingly, the setting modifier 234 may access the ringing volume application on the second device and assign it a value of “5.” In some embodiments, if a media file is associated with the particular setting data, the setting modifier 234 may analyze the XML file to identify the storage location of the file. In this, if the file is found in the storage location, the setting modifier 234 may associate the file with the setting data. As an example, the setting modifier 234 may determine that the wallpaper application has a value of “Friends.jpg”. The setting modifier 234 may further determine that the setting data has a media file associated therewith based at least in part of the storage location tag, which may indicate wallpaper folder. As such, the setting modifier 234 may access the wallpaper folder to ensure that the file is available and thus direct a pointer from the wallpaper application to “Friends.jpg” in the wallpaper folder. However, if the file is not found, according to some embodiments, the setting modifier 234 may not modify the settings of the application and maintain the default or factory setting of the application.

The device set-up manager 230 and/or the setting modifier 234 may be configured to display the current settings of the second device to the user. In some embodiments, the settings may be displayed after the second device has been personalized. As mentioned above, the settings of the second device may be personalized based on the compatible user preferred or personal settings data of the first phone. In this regard, the settings that were personalized on the second device based at least in part on the first device, along with the settings that were not personalized on the second device may be displayed to the user as the default settings of the second device. In other embodiments, the current settings of the second device may be displayed even if the setting modifier 234 does not apply to any user preferred or personal settings data from the first device. In some embodiments, the setting modifier 234 may not delete the default settings of the second device. In this regard, the user may be able to revert to the default or factory settings of the second device.

In some embodiments, the settings of the application(s) modified regularly by the user on the first device may be displayed in a prominent fashion. In this regard, the data retriever 232 may, for example, analyze a log of user interactions with various application(s) on the first device and provide that information to the device set-up manager 230 and/or the setting modifier 234.

FIG. 5 is a flowchart of a system, method, and program product according to example embodiments of the invention. It will be understood that each block, step, or operation of the flowcharts, and combinations of blocks, steps or operations in the flowcharts, may be implemented by various means, such as hardware, firmware, and/or software including one or more computer program instructions, program instructions, or executable program instructions. For example, one or more of the procedures described above may be embodied by computer program code instructions. In this regard, the computer program instructions which embody the procedures described above may be stored by a memory device, e.g. memory device 210, and executed by a processor, e.g. processor 205. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s), step(s), or operation(s). These computer program instructions may also be stored in a computer-readable memory that may direct a computer, a processor, or other programmable apparatus to function in a particular manner, such that the instructions stored in the computer-readable memory produce an article of manufacture including instruction means which implement the function specified in the flowcharts block(s), step(s), or operation(s). The computer program instructions may also be loaded onto a computer, processor, or other programmable apparatus to cause a series of operational steps to be performed on the computer, processor, or other programmable apparatus to produce a computer-implemented process such that the instructions which execute on the computer, processor, or other programmable apparatus provide steps for implementing the functions specified in the flowcharts block(s), step(s), or operation(s).

Accordingly, blocks, steps, or operations of the flowcharts support combinations of means for performing the specified functions, combinations of steps for performing the specified functions and program instruction means for performing the specified functions. It will also be understood that one or more blocks, steps, or operations of the flowcharts, and combinations of blocks, steps, or operations in the flowcharts, may be implemented by special purpose hardware-based computer systems which perform the specified functions or steps, or combinations of special purpose hardware and computer instructions.

In this regard, one example embodiment of a method for personalizing a device as illustrated in FIG. 5 may include receiving a request to personalize a second device based at least on a first device at step 500. In some embodiments, the personalization of the second device may be based at least in part on at least one setting of at least one application of the first device. The user device may, but need not be, a device that may be replacing the first device. In other embodiments, the user device and the first device may both be mobile terminals, but other types of data can also be employed.

The example method of FIG. 5 may also include comparing at least one application from the first device to at least one application from the second device at step 510. There may be various methods for performing the comparison. In some embodiments, each application of the first device may be compared to one or more applications of the second device. The comparison may be performed to identify same or similar applications between the first device and the second device, or in other words, to identify compatible applications.

The example method of FIG. 5 may further include determining at least one setting data to be retrieved from the first device based at least in part on the comparison at step 520. In this regard, the data and/or content of the first device may be analyzed to identify data compatible with the second device.

The example method of FIG. 5 may additionally include retrieving at least one user preferred or personal setting data from the first device at step 530. The compatible data may be retrieve and/or transferred from the first device to the user device via various communications techniques such as, for example, infrared, wireless LAN, or BlueTooth. In some embodiments, the compatible data that may be retrieved and/or transferred from the first device may be recorded on a file that may be stored on the user device.

The example method of FIG. 5 may further include modifying at least one setting of the user device based at least in part on one user preferred or personal setting of the first device at step 540. In some embodiments, the user preferred or personal setting of the first device may have been retrieved and/or transferred to the user device. In other embodiments, the user preferred or personal setting may have been recorded on a file stored on the user device. In this regard, at least one setting of the user device may be modified based at least in part analyzing the content of the file. As such, several advantages may be achieved. In this regard and as example, switching from a first device to a second device may be facilitated. As a further example, the customizing process of a second device may be less of hassle and less time consuming. Additionally, the barrier of entry to new devices may be removed and as such, starting the usage of a previous device easier.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving a request to personalize a second device based at least in part on a first device;
comparing at least one application from the first device to at least one application from the second device;
determining at least one setting data to be retrieved from the first device based at least in part on the comparison;
retrieving the at least one setting data from the first device; and
modifying at least one setting of at least one application of the second device based at least in part on the retrieved setting data.

2. The method of claim 1, wherein retrieving the at least one setting data comprises transferring data from the first device to the second device.

3. The method of claim 1, wherein retrieving the at least one setting data comprises writing information to a file related to the retrieved setting data.

4. The method of claim 3, wherein modifying the at least one setting of a corresponding application of the second device comprises reading the information related to the retrieved setting data from the file.

5. The method of claim 2, wherein transferring data comprises transferring data to a location associated with at least one application of the second device.

6. The method of claim 1, wherein the second device and the first device are mobile terminals.

7. An apparatus comprising a processor, the processor configured to:
receive a request to personalize a second device based at least in part on a first device;
compare at least one application from the first device to at least one application from the second device;
determine at least one setting data to be retrieved from the first device based at least in part on the comparison;
retrieve the at least one setting data from the first device; and
modify at least one setting of at least one application of the second device based at least in part on the retrieved setting data.

8. The apparatus of claim 7, wherein the processor being configured to retrieve the at least one setting data comprises being configured to transfer data from the first device to the second device.

9. The apparatus of claim 7, wherein the processor being configured to retrieve the at least one setting data comprises being configured to write information to a file related to the retrieved setting data.

10. The apparatus of claim 9, wherein the processor being configured to modify the at least one setting of a corresponding application of the second device comprises being configured to read the information related to the retrieved setting data from the file.

11. The apparatus of claim 8, wherein the processor being configured to transfer data comprises being configured to transfer data to a location associated with at least one application of the second device.

12. The apparatus of claim 7, wherein the first device and the second device are mobile terminals.

13. A computer program product comprising at least one computer-readable storage medium having computer-readable program instructions stored therein, the computer-readable program instructions comprising:
a first program instruction configured to receive a request to personalize a second device based at least in part on a first device;
a second program instruction configured to compare at least one application from the first device to at least one application from the second device;
a third program instruction configured to determine at least one setting data to be retrieved from the first device based at least in part on the comparison;
a fourth program instruction configured to retrieve the at least one setting data from the first device; and
a fifth program instruction configured to modify at least one setting of at least one application of the second device based at least in part on the retrieved setting data.

14. The computer program product of claim 13, wherein the fourth program instruction configured to retrieve the at least one setting comprises a program instruction configured to transfer data from the first device to the second device.

15. The computer program product of claim 13, wherein the fourth program instruction configured to retrieve the at least one setting data comprises a program instruction to write to a file information related to the retrieved setting data.

16. The computer program product of claim 15, wherein the fifth program instruction configured to modify the at least one setting of a corresponding application of the user device comprises a program instruction configured to read the information related to the retrieved setting data from the file.

17. The computer program product of claim 14, wherein the program instruction configured to transfer data comprises a program instruction configured to transfer data to a location associated with at least one application of the second device.

18. The computer program product of claim 13, wherein the second device and the first device are mobile terminals.

19. An apparatus comprising:
means for receiving a request to personalize a second device based at least in part on a first device;
means for comparing at least one application from the first device to at least one application from the second device;
means for determining at least one setting data to be retrieved from the first device based at least in part on the comparison;
means for retrieving the at least one setting data from the first device; and
means for modifying at least one setting of at least one application of the second device based at least in part on the retrieved setting data.

20. The apparatus of claim 19, wherein the means for retrieving the at least one setting data comprises a means for transferring data from the first device to the second device.
